(19) United States
(12) Patent Application Publication
(10) Pub. No.: US 2020/0147796 A1
(43) Pub. Date: May 14, 2020

(54) MOVING METHOD AND DEVICE FOR A ROBOT, ROBOT, ELECTRONIC APPARATUS AND READABLE MEDIUM

(71) Applicant: CLOUDMINDS (SHENZHEN) ROBOTICS SYSTEMS CO., LTD., Shenzhen (CN)

(72) Inventor: Lianzhong LI, Shenzhen (CN)

(21) Appl. No.: 16/728,629

(22) Filed: Dec. 27, 2019

Related U.S. Application Data
(63) Continuation of application No. PCT/CN2019/116109, filed on Nov. 6, 2019.

(30) Foreign Application Priority Data
Nov. 12, 2018 (CN) 201811339939.5

(51) Int. Cl. B25J 9/16; B25J 13/08; G05D 1/02

(52) U.S. Cl. CPC B25J 9/1666; B25J 9/1651; G05D 1/0223; G05D 1/0214; B25J 13/089

(57) ABSTRACT

A method, device, robot, electronic apparatus, and computer readable medium for controlling a movement of a robot is provided. The method includes: determining a current attitude, a target attitude and a moving speed of the robot; determining a moving path according to a third-order Bézier curve, the current attitude and the target attitude; determining a moving angular velocity according to the moving path and the moving speed; and controlling the robot to move at the moving speed and the moving angular velocity so as to reach the target attitude. The method, device, robot, electronic apparatus and the computer readable medium for controlling moving of a robot enable the robot to smoothly move from a start point to a target point.

### CROSS-REFERENCE TO RELATED APPLICATION

This application is a continuation application to PCT/CN2019/116109, with an international filing date of Nov. 6, 2019, which is based on Chinese Application No. 201811339939.5, having a filing date of Nov. 12, 2018, the entire contents both of which are hereby incorporated by reference.

### FIELD OF TECHNOLOGY

The following relates to the field of robot control, and in particular, to a method, device, a robot, an electronic apparatus and a computer readable medium for controlling moving of a robot.

### BACKGROUND

With the development of science and technology, robots have been applied to an increasingly expanding application area, and it becomes more common that robots replace humans to complete tasks. There are many ways for robot path planning, such as typical artificial potential field method, grid method, genetic algorithm and so on. When a robot starts roaming, firstly, a global planner performs global static planning based on the existing long-term information to determine an optimal path that a virtual human should follow. Then the global planner controls an execution system to move according to the path.

However, for mobile robots, especially outdoor patrol robots, movement scenarios are very complicated, and obstacles may be encountered at any time. When the robot encounters an obstacle, it is necessary to quickly and effectively change the path for the robot. In this scenario, the global path planning method for controlling moving of the robot is not applicable. During moving of the robot, a robot perception system would continuously perceive its surrounding environment. When a dynamic object or an unknown obstacle is found, a local planner may be enabled to determine a motion for a short period based on perceived local information. If a higher priority is set for an obstacle-avoiding behavior as compared with proceeding along the original path, the local planner may obtain control over the execution system through competition, so that the virtual human moves according to a result of local planning. After completing the avoiding behavior to the currently perceived obstacle, the global planner again has control over the execution system, so that the virtual human returns back to the global planning path and continues to move towards its target point.

The inventor found that at least the following problems exist in the conventional art: the obstacle-avoiding behavior of the robot has to perform a prompt and effective change of the path for the robot in a short time, however, according to methods in the conventional art, unsteadiness often occurs during movement of the robot when rapidly changing the path of the robot. Therefore, a new method, device, robot, electronic apparatus, and computer readable medium for controlling moving of a robot are required.

The above information disclosed in this Background section is only used to strength understanding of the background of the application, and thus it may include information that does not constitute conventional art known to those of ordinary skill in the art.

### SUMMARY

An aspect relates to a method, device, robot, electronic apparatus and computer readable medium for controlling moving of a robot, which may control a robot to smoothly move from a start point to a target point.

According to an aspect of the application, a method for controlling moving of a robot is provided, including: determining a current attitude, a target attitude and a moving speed of the robot; determining a moving path according to a third-order Bézier curve, the current attitude and the target attitude; determining a moving angular velocity according to the moving path and the moving speed; and controlling the robot to move at the moving speed and the moving angular velocity so as to reach the target attitude.

According to an aspect of the application, a device for controlling moving of a robot is provided, comprising: a state module configured to determine a current attitude, a target attitude and a moving speed of the robot; a path module configured to determine a moving path according to a third-order Bézier curve, the current attitude and the target attitude; an angular velocity module configured to determine a moving angular velocity according to the moving path and the moving speed; and a moving module configured to enable the robot to move at the moving speed and the moving angular velocity so as to reach the target attitude.

According to an aspect of the application, a robot is provided, a control system configured to determine a current attitude, a target attitude and a moving speed of the robot; determine a moving path according to a third-order Bézier curve, the current attitude and the target attitude; determine a moving angular velocity according to the moving path and the moving speed; and generate a moving command by determining the moving angular velocity according to the moving speed; and a moving system configured to receive the moving command, and move the robot according to the moving command so as to reach the target attitude.

According to an aspect of the application, an electronic apparatus is provided, which includes: one or more processors; a memory configured for storing one or more programs; wherein when being executed by the one or more processors, the one or more programs cause the one or more processors to implement the method described above.

According to an aspect of the application, there is provided a computer readable medium having stored thereon a computer program, wherein the program implements the method described above when being executed by a processor.

According to the method, device, robot, electronic apparatus, and computer readable medium for controlling the moving of a robot in the present application, it is possible to control the robot to smoothly move from the start point to the target point.

It shall be understood that the above general description and the following detailed description are merely exemplary and are not intended to limit the application.

### BRIEF DESCRIPTION

Some of the embodiments will be described in detail, with references to the following Figures, wherein like designations denote like members, wherein:

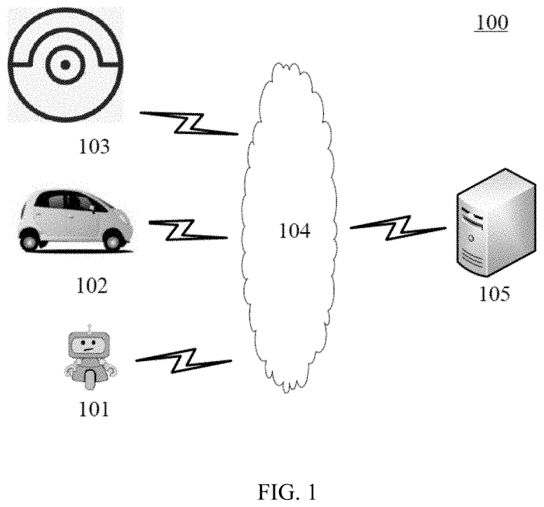

FIG. 1 is a system block diagram illustrating a method and a device for controlling moving of a robot according to an exemplary embodiment;

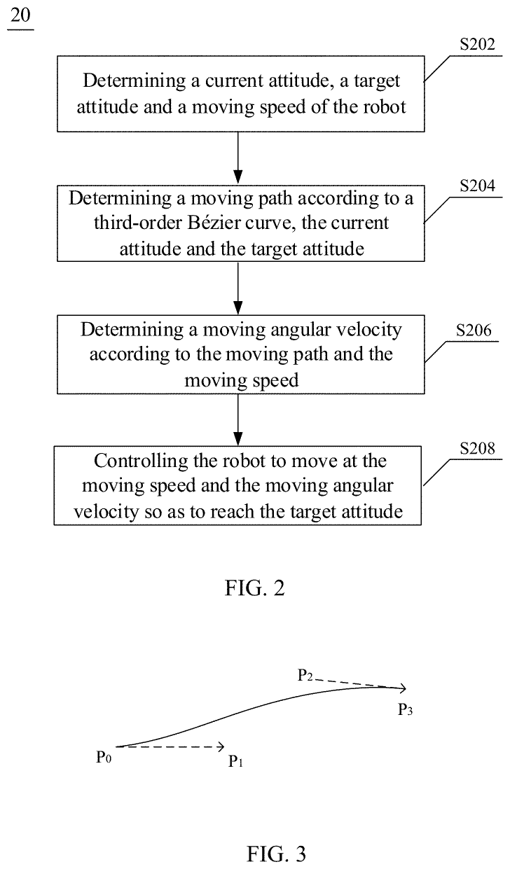

FIG. 2 is a flow chart illustrating a method for controlling moving of a robot according to an exemplary embodiment;

FIG. 3 is a schematic diagram illustrating a third-order Bézier curve in a method for controlling moving of a robot according to an exemplary embodiment;

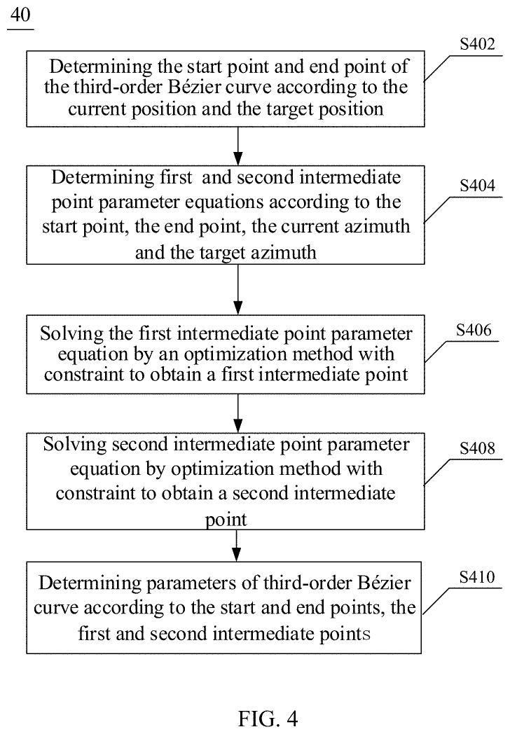

FIG. 4 is a flow chart illustrating a method for controlling moving of a robot according to another exemplary embodiment;

FIG. 5 is a block diagram illustrating a device for controlling moving of a robot according to an exemplary embodiment;

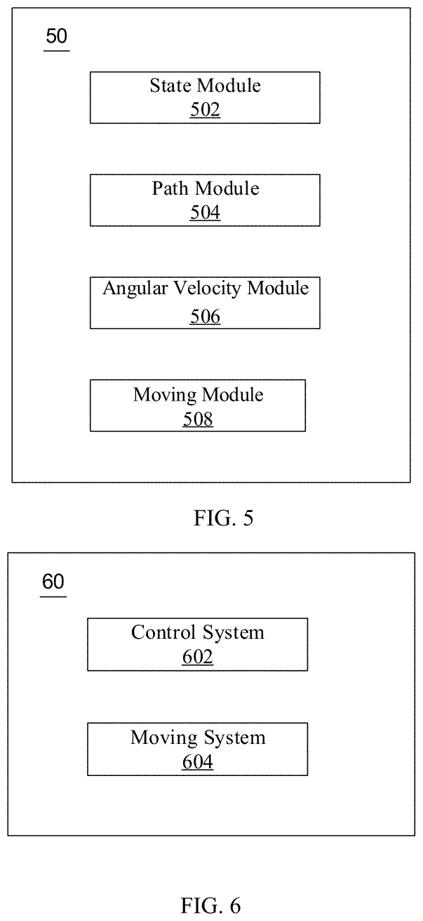

FIG. 6 is a block diagram illustrating a robot system according to another exemplary embodiment;

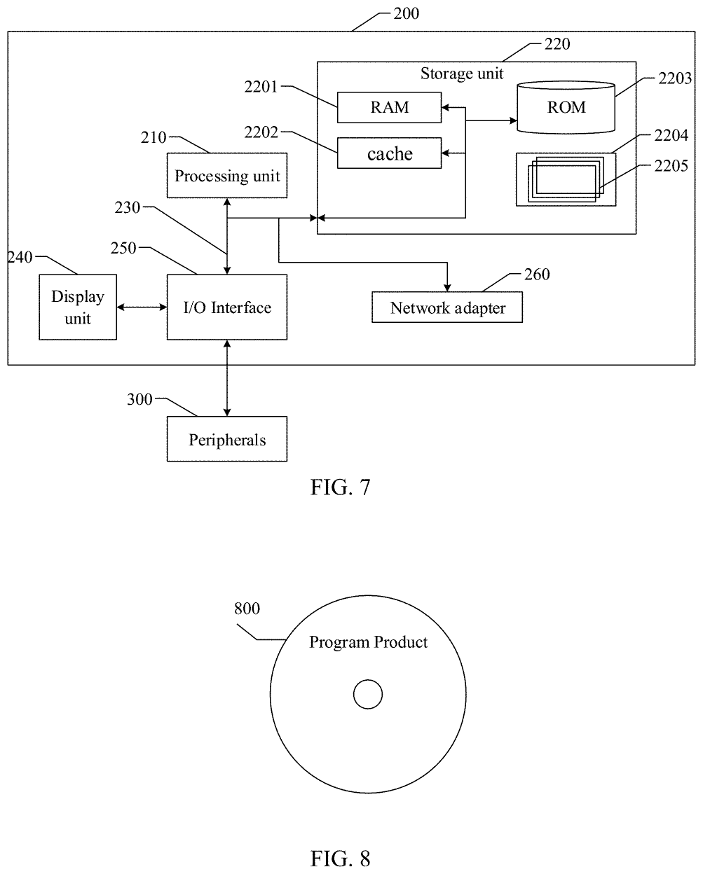

FIG. 7 is a block diagram illustrating an electronic apparatus according to an exemplary embodiment; and

FIG. 8 is a schematic diagram illustrating a computer readable storage medium according to an exemplary embodiment.

### DETAILED DESCRIPTION

Example embodiments will be described more comprehensively hereinafter with reference to the accompanying drawings. However, the example embodiments can be embodied in a variety of forms and should not be construed as being limited to the examples set forth herein; rather, these embodiments are provided such that this disclosure will be more comprehensive and complete, and the idea of the example embodiments will be comprehensively conveyed to those skilled in the art. The same reference numerals in the drawings denote the same or similar parts, and the repeated description thereof will be omitted.

Furthermore, the described features, structures, or characteristics may be combined in any suitable manner in one or more embodiments. In the following description, numerous specific details are set forth to facilitate fully understanding the embodiments of the present disclosure. However, those skilled in the art will appreciate that the technical solutions of the present disclosure may be practiced without one or more of the specific details, or other methods, components, devices, steps, etc. may also be employed. In other instances, methods, devices, implementations, or operations that are well-known are not shown or described in detail to avoid obscuring aspects of the present disclosure.

The block diagrams shown in the drawings are merely functional entities, which do not necessarily correspond to physically separated entities. That is, these functional entities may be implemented in software, or implemented in one or more hardware modules or integrated circuits, or implemented in different networks and/or processor devices and/or microcontroller devices.

The flowcharts shown in the drawings are merely illustrative, which do not necessarily include all of the contents and operations/steps and are not necessarily performed in the described order. For example, some operations/steps may be decomposed, and some operations/steps may be combined or partially combined, so the actual execution order may vary depending on actual situations.

It will be understood that the terms “first”, “second”, “third”, etc. may be used herein to describe various components, however, these components are not limited by these terms. These terms are herein used to distinguish one component from another. Thus, a first component discussed below may also be termed a second component without departing from the teachings of the present application. The term “and/or” as used herein includes any one of the associated listed items and all of the combinations of one or more of the associated listed items.

Those skilled in the art shall understand that the drawings are only for schematically illustrating the exemplary embodiments, and the modules or processes in the drawings are not necessarily required for implementing the present disclosure, and therefore are not intended to limit the scope of the present disclosure.

The inventor of the present application has found that for mobile robots, especially outdoor patrol robots, the movement scenarios are very complicated, and obstacles may be encountered at any time, thus the path for the robot needs to be changed. In this case, the global path planning method is not applicable. In view of the technical defects in the conventional art, the inventor of the present application proposes a robot speed planning method based on a third-order Bézier curve, which plans the speed of the robot in real time by using properties of the Bézier curve.

The method for controlling moving of a robot in the present application takes the “maximum curvature minimization” as an objective function, obtains a control point for Bézier curve by an optimized method, and thus obtains a parameter equation; and then plans the speed of the robot in real time according to the parameter equation in combination with the real-time position of the robot and the Bézier curve curvature. The method for controlling moving of a robot in the present application plans a linear velocity and an angular velocity of the robot in real time according to the already known initial and ending positions and attitudes of the robot.

The details of this application will be described below.

FIG. 1 is a system block diagram illustrating a method and device for controlling moving of a robot according to an exemplary embodiment.

As shown in FIG. 1, a system architecture 100 may include terminal devices 101, 102, 103, a network 104 and a server 105. The network 104 is configured to provide a medium for communication links between the terminal devices 101, 102, 103 and the server 105. The network 104 may include various types of connections, such as wired communication links, wireless communication links, fiber optic cables, and the like.

The terminal devices 101, 102, 103 interact with the server 105 over the network 104 to receive or transmit messages and the like. The terminal devices 101, 102, 103 may be installed with various communication client applications, such as search applications, instant messaging tools, and the like.

The terminal devices 101, 102, and 103 may be an electronic apparatus having control function and moving function, including but not limited to intelligent robot, patrol robot, central control device for self-driving car, intelligent home, and the like.

The storage unit and processing unit in the terminal devices 101, 102, 103 may provide real-time path planning for the terminal devices 101, 102, 103 when they are moving. The terminal devices 101, 102, 103 may determine, for example, a current attitude, a target attitude, and a moving speed. The terminal devices 101, 102, 103 may determine a moving path according to a third-order Bézier curve, the current attitude and the target attitude, for example. The terminal devices 101, 102, 103 may determine the moving angular velocity according to the moving path and the moving speed, for example. The terminal devices 101, 102, 103 may move, for example, at the moving speed and the moving angular velocity so as to reach a target attitude.

The server 105 may be a server that provides various services, such as a background server that provides real-time path planning for the terminal devices 101, 102, 103 when these terminal devices are moving. The background server may process, such as analyze, the received real-time path data, and feedback the processing result (e.g., angular velocity, moving track, real-time speed, etc.) to the terminal devices 101, 102, 103, so that the terminal devices 101, 102, 103 move according to the processing result.

The terminal devices 101, 102, 103 may, for example, upload a current state to the server 105 in real time; and the server 105 may, for example, determine the current attitude, the target attitude and the moving speed of the terminal devices 101, 102, 103. The server 105 may, for example, determine the moving path according to the third-order Bézier curve, the current attitude, and the target attitude. The server 105 may determine the moving angular velocity, for example, according to the moving path and the moving speed. The server 105 may, for example, control the terminal devices 101, 102, 103 to move at the moving speed and the moving angular velocity so as to reach the target attitude.

The server 105 may be a physical server and may also be composed of a plurality of servers, for example. It should be noted that the method for controlling moving of a robot provided by the embodiment of the present application may be performed by the server 105 or may be performed by the terminal devices 101, 102, 103. Accordingly, the device for controlling moving of a robot may be provided in the server 105 or in the terminal devices 101, 102, 103.

FIG. 2 is a flow chart illustrating a method for controlling moving of a robot according to an exemplary embodiment. The method 20 for controlling moving of a robot includes at least steps S202 to S208.

As shown in FIG. 2, in S202, a current attitude, a target attitude and a moving speed of the robot are determined. The current attitude and the target attitude are the initial and ending positions and attitudes of the robot, respectively. Specifically, for example, the current attitude X₀=(x₀, y₀, θ₀) includes a current position and a current azimuth; and the target attitude Xₙ=(xₙ, yₙ, θₙ) includes a target position and a target azimuth.

In S204, a moving path is determined according to a third-order Bézier curve and the current attitude and the target attitude.

The Bézier curve is a mathematical curve applied to a two-dimensional graphics application. Due to smooth characteristics possessed by the Bézier curve, the Bézier curve has been widely used in industrial control.

In one embodiment, data points and a control point are required to generate a Bézier curve.

The data points refer to a start point and an end point of a path.

The control point refers to a point that determines a curving track of the path. According to the number of control points, the Bézier curve is classified into a first-order Bézier curve (0 control points), a second-order Bézier curve (1 control point), and a third-order Bézier curve (2 control points) and so on.

In one embodiment, the step of determining the moving path according to the third-order Bézier curve, the current attitude and the target attitude includes: calculating parameters of the third-order Bézier curve according to the current position, the current azimuth, the target position and the target azimuth; and determining the moving path according to the parameters of the third-order Bézier curve.

In one embodiment, specifically, the moving path may be determined according to the third-order Bézier curve having two control points. The process for generating the moving path specifically includes taking the initial and ending positions of the robot as the data points of the Bézier curve and obtaining two control points to determine the third-order Bézier curve, and the generated third-order Bézier curve is shown in FIG. 3, for example.

In S206, a moving angular velocity is determined according to the moving path and the moving speed. Specifically, the determining may for example include: determining a speed update cycle for the robot; determining a number of speed update for the robot; determining a moving period; and determining the moving angular velocity according to the moving period, the speed update cycle and a number of speed update. The speed update cycle, the number of speed update, and the moving period for the robot may all be specified by the user.

In one embodiment, the speed update cycle, the number of speed update and the moving period for the robot may also be determined through an optimization calculation, according to the time for the robot to complete the task and the current time, for example.

In one embodiment, the step of determining the number of speed update for the robot includes determining a path length of the moving path; and determining the number of speed update according to the path length, the moving speed and the speed update cycle. Wherein, the path length may be determined by calculating a curve length of the third-order Bézier curve; and the moving speed may be specified by the user.

In S208, the robot is controlled to move at the moving speed and the moving angular velocity so as to reach the target attitude. Wherein, the driving mode of the robot is a rear-drive type.

The driving mode refers to the arrangement of the engine and the number and positions of the driving wheels. A typical mobile terminal has two rows of wheels respectively in front and in rear of the mobile terminal, wherein the wheels that are directly driven by the engine to rotate so as to push (or pull) the vehicle forward are driving wheels.

The driving wheels may be classified into two categories according to the number thereof: two-wheel drive and four-wheel drive. According to the position of the engine in the vehicle and the position of the driving wheels, the two-wheel drive is classified into four types: front engine rear drive (FR), front engine front drive (FF), rear engine rear drive (RR), and middle engine rear drive (MR). In the present application, the robot may be, for example, a forward rotate Rear Drive robot.

It is worth mentioning that in the conventional art, most of the vehicles are also rear-drive vehicles, so the method for controlling moving of a robot in the present application may also be applied to the automobile control field for automatic driving.

According to the method for controlling moving of a robot of the present application, by generating the moving path for the robot according to the third-order Bézier curve and determining the speed and angular velocity for the robot during movement according to the moving path, the robot may be controlled to move steadily from the start point to its target point.

It should be clearly understood that the present application describes how to make and use particular examples, but the principle of the application is not limited to any details of these examples. Rather, the principle may be applied to many other embodiments based on the teachings of the disclosure herein.

FIG. 4 is a flow chart illustrating a method for controlling moving of a robot according to another exemplary embodiment. The flow shown in FIG. 4 is a detailed description for the step of “determining the moving path according to the third-order Bézier curve, the current attitude and the target attitude” in S204 in the flow shown in FIG. 2.

As shown in FIG. 4, in S402, a start point and an end point of the third-order Bézier curve are determined according to the current position and the target position.

In S404, a first intermediate point parameter equation and a second intermediate point parameter equation are determined by the start point, the end point, the current azimuth and the target azimuth.

In S406, the first intermediate point parameter equation is solved by an optimization method with constraint to obtain a first intermediate point. Where, an optimization objective of the optimization method includes minimizing a value of a maximum curvature of the third-order Bézier curve. The constraint of the optimization method includes that the maximum curvature of the third-order Bézier curve is less than a predetermined value; and both the value of the first intermediate point and the value of the second intermediate point are greater than zero.

In S408, the second intermediate point parameter equation is solved by the optimization method with constraint to obtain a second intermediate point. Where, the optimization objective of the optimization method includes minimizing a value of a maximum curvature of the third-order Bézier curve. The constraint of the optimization method includes that the maximum curvature of the third-order Bézier curve is less than a predetermined value; and both the value of the first intermediate point and the value of the second intermediate point are greater than zero.

In S410, the parameters of the third-order Bézier curve are determined according to the start point, the end point, the first intermediate point and the second intermediate point.

The process of generating the moving path according to the third-order Bézier curve is described below. As described above, the third-order Bézier curve is a planar third-order Bézier curve uniquely determined by four control points. The basic characteristics thereof are indicated as follows.

The parameter equation of the third-order Bézier curve is:

P(u)=P₀(1−u)³+3P₁(1−u)²u+3P₂(1−u)u²+P₃u³,u∈[0,1]

The start point and end point of the Bézier curve are:

P(0)=P₀

P(1)=P₃

The tangent vector of the ends of the Bézier curve is:

P′(0)=3(P₁−P₀)

P′(1)=3(P₄−P₃)

The curvature of the Bézier curve at any point is:

$$κ ( u ) = \frac{{x}^{′} ( u ) {y}^{″} ( u ) - {y}^{′} ( u ) {x}^{″} ( u )}{{( {x}^{′ 2} ( u ) + {y}^{′ 2} ( u ) )}^{1.5}}$$

The Bézier curve has a characteristic of being invariant to affine transformation. In order to ensure smoothness of the planned robot track, the generated third-order Bézier curve should meet the following requirements:

the start point and end point of the Bézier curve are the start point and target point of the robot.

the tangent vector of the start point and end point of the Bézier curve is parallel to the attitude of the robot; and

the curvature of the Bézier curve should be continuous and bounded.

Assuming that the initial attitude of the robot is X₀=(x₀, y₀, θ₀), and the target attitude is Xₙ=(xₙ, yₙ, θₙ), where θ is the azimuth of the robot. To meet the above requirements, the four control points (start point P₀, first intermediate point P₁, second intermediate point P₂ and end point P₃) that generate the third-order Bézier curve are represented as:

$$\{ \begin{matrix}{P}_{0} = [ {x}_{0} , {y}_{0} ] \\ {P}_{1} = [ {x}_{0} + {d}_{1} \cdot cos ( {θ}_{0} ) , {y}_{0} + {d}_{1} \cdot sin ( {θ}_{0} ) ] \\ {P}_{2} = [ {x}_{n} - {d}_{2} \cdot cos ( {θ}_{n} ) , {y}_{n} - {d}_{2} \cdot sin ( {θ}_{n} ) ] \\ {P}_{3} = [ {x}_{n} , {y}_{n} ]\end{matrix}$$

wherein, d₁=|P₀P₁|, d₂=|P₂P₃|.

Through the above parameterization method, it can be known that the third-order Bézier curve has two unknown parameters d₁ and d₂. To ensure the continuity and boundedness of the curvature, d₁ and d₂ may be obtained by the optimization method, and the optimization objective function is set so that the value of the maximum curvature of the third-order Bézier curve is minimized:

J(d₁,d₂)=κₘₐₓ(uₘ)

wherein, uₘ is u that maximizes the value of the curvature of the curve.

The optimization parameters of the above objective function are d₁ and d₂, so that the maximum curvature of the robot is minimized, thereby the moving track of the robot is relatively smooth, and the problem of speed optimization is finally transformed into a problem of conditionally constrained nonlinear optimization, that is:

minimize: J(d₁,d₂)

s.t. κₘₐₓ(u)≤Kₘₐₓ

d₁>0

d₂>0

Up to now, the four control points of the third-order Bézier curve have been obtained, that is, the parameter equation of the curve is obtained, and thus the curvature at any point on the curve can be obtained.

For the mobile robot, in order to ensure that the robot moves along the planned third-order Bézier curve, it is only necessary to ensure that the turning radius of the robot at any time is equal to the radius of curvature at a position on the curve where the robot is located at the same time. Assuming that the robot moves from the start point to the target point at a linear velocity v(t), thus the angular velocity of the robot may be represented as:

ω(t)=v(t)·κ(u)

wherein, u=f(t)

If the robot moves strictly at the planned speed [v, w], the robot's moving path is the planned third-order Bézier curve, thus enabling the robot to smoothly reach the target attitude.

It is worth mentioning that in one embodiment, in the process of solving the parameters of the third-order Bézier curve, other optimization methods may be employed, for example, and the optimization objective may also be adjusted according to actual needs which is not limited in the present application.

In the following, through a specific embodiment, the specific calculation process for the angular velocity and the moving path during movement of a robot will be described.

Assuming that the initial attitude of the robot is X₀=(x₀, y₀, θ₀), and the target attitude is Xₙ=(xₙ, yₙ, θₙ), the four control points of the third-order Bézier curve are:

$$\{ \begin{matrix}{P}_{0} = [ {x}_{0} , {y}_{0} ] \\ {P}_{1} = [ {x}_{0} + {d}_{1} \cdot cos ( {θ}_{0} ) , {y}_{0} + {d}_{1} \cdot sin ( {θ}_{0} ) ] \\ {P}_{2} = [ {x}_{n} - {d}_{2} \cdot cos ( {θ}_{n} ) , {y}_{n} - {d}_{2} \cdot sin ( {θ}_{n} ) ] \\ {P}_{3} = [ {x}_{n} , {y}_{n} ]\end{matrix}$$

According to the optimization function,

minimize: J(d₁, d₂)

s.t. κₘₐₓ(t)≤Kₘₐₓ

d₁>0

d₂>0

then, the optimal d₁ and d₂ are obtained.

The parameter equation of the third-order Bézier curve is:

P(u)=P₀(1−u)³+3P₁(1−u)²t+3P₂(1−u)t²+P₃u³,u∈[0,1]

The total length of the Bézier curve is:

S=∫₀¹P(u)du

Assuming that the robot is moving at a constant speed v₀ over the entire curve and the speed update cycle for the robot is Δt, the total number of speed update for the robot is calculated as follows:

$$N = \frac{S}{v \cdot Δ t}$$

The angular velocity at which the robot moves is calculated as follows:

$$ω ( t ) = \frac{t}{N \cdot Δ t}$$

$$t ∈ [ 0 , S / {v}_{0} ]$$

According to the moving method for a robot in the present application, the robot moves at a speed [v₀, w], thus may move smoothly from the start point to the target point.

Those skilled in the art will appreciate that all or a portion of the steps to implement the above-described embodiments are implemented as a computer program executed by a CPU. When the computer program is executed by the CPU, the above functions defined by the above method provided by the present application are executed. The program may be stored in a computer readable storage medium, such as a read only memory, a magnetic disk or an optical disk, or the like.

Further, it should be noted that the above described drawings are provided merely for schematic describing the processes included in the method according to the exemplary embodiments of the present application but are not intended to be limiting. It is readily understood that the processes shown in the above drawings do not indicate or limit the chronological order of these processes. In addition, it is also readily understood that these processes may be performed synchronously or asynchronously in a plurality of modules, for example.

The following is an embodiment for the device of the present application, which may be used to implement the embodiments for the method of the present application. For details not disclosed in the embodiments for the device of the present application, please refer to embodiments for the method of the present application.

FIG. 5 is a block diagram illustrating a device for controlling moving of a robot according to an exemplary embodiment. The device 50 for controlling moving of a robot includes a state module 502, a path module 504, an angular velocity module 506, and a movement module 508.

The state module 502 is configured to determine a current attitude, a target attitude and a moving speed of the robot. Where, the current attitude and the target attitude refer to initial and ending positions and attitudes of the robot.

The path module 504 is configured to determine a moving path according to a third-order Bézier curve, the current attitude, and the target attitude. In one embodiment, determining the moving path according to the third-order Bézier curve, the current attitude and the target attitude includes: calculating parameters of the third-order Bézier curve according to a current position, a current azimuth, a target position and a target azimuth; and determining the moving path according to the parameters of the third-order Bézier curve.

The angular velocity module 506 is configured to determine a moving angular velocity according to the moving path and the moving speed. For example, it may include: determining a speed update cycle for the robot, determining a number of speed update for the robot, and determining a moving period; and then determining the moving angular velocity according to the moving period, the speed update cycle and the number of speed update. Where, the speed update cycle of the robot, the number of speed update and the moving period may all be specified by the user.

The moving module 508 is configured to enable the robot to move at the moving speed and the moving angular velocity so as to reach the target attitude. The robot is a robot of a rear drive type in terms of the driving mode.

The device for controlling moving of a robot according to the present application generates a moving path of the robot according to the third-order Bézier curve, and determines the speed and angular velocity of the robot movement according to the moving path in the way so as to control the robot to smoothly move from the start point to the target point.

FIG. 6 is a system block diagram of a robot according to another exemplary embodiment. The robot 60 includes a control system 602, and a moving system 604.

The control system 602 is configured to determine a current attitude, a target attitude and a moving speed of the robot; determine a moving path according to a third-order Bézier curve, the current attitude and the target attitude; determine a moving angular velocity according to the moving path and the moving speed; and generate a moving command by determining the moving angular velocity according to the moving speed.

The moving system 604 is configured to receive the moving command and move the robot according to the command to enable the robot so as to reach the target attitude.

FIG. 7 is a block diagram illustrating an electronic apparatus according to an exemplary embodiment.

The electronic apparatus 200 according to the embodiment of the present application is described below with reference to FIG. 7. The electronic apparatus 200 shown in FIG. 7 is merely an example, and shall not be construed as a limitation on the function and scope of the embodiments of the present disclosure.

As shown in FIG. 7, the electronic apparatus 200 may be implemented by a general purpose computing device. The components of the electronic apparatus 200 may include but not limit to: at least one processing unit 210, at least one storage unit 220, a bus 230 connecting different system components (including the storage unit 220 and the processing unit 210), a display unit 240, and the like.

The storage unit stores a program code, and the program code may be executed by the processing unit 210, such that the processing unit 210 performs steps in the exemplary embodiments of the present disclosure. For example, the processing unit 210 can perform steps shown in FIG. 2 or FIG. 4.

The storage unit 220 may include a readable medium in form of a volatile storage unit, such as a Random Access Memory unit (RAM) 2201 and/or a cache storage unit 2202 and may further include a Read Only Memory unit (ROM) 2203.

The storage unit 220 may also include a program/utility tool 2204 having a set of program modules 2205 (at least one program module), including but not limiting to: an operating system, one or more applications, other program modules, and program data, each or some combination of these examples may include an implementation of a network environment.

The bus 230 may be represented as one or more of several types of bus architectures, including a memory unit bus or memory unit controller, a peripheral bus, an Accelerated Graphics Port, a processing unit, or a local bus using any of a variety of bus architectures.

The electronic apparatus 200 can also communicate with one or more peripherals 300 (e.g, a keyboard, a pointing device, a Bluetooth device, etc.), and can also communicate with one or more devices that enable the user to interact with the electronic apparatus 200, and/or with any devices (e.g., a router, a modem, etc.) that enables the electronic apparatus 200 to communicate with one or more other computing devices. This communication can take place via an input/output (I/O) interface 250. Moreover, the electronic apparatus 200 can also communicate with one or more networks (e.g., Local Area Network (LAN), Wide Area Network (WAN), and/or a public network, such as the Internet) via a network adapter 260. The network adapter 260 may communicate with other modules of the electronic apparatus 200 via the bus 230. It should be understood that although not shown in the figures, other hardware and/or software modules may be utilized in conjunction with electronic apparatus 200, including but not limiting to: a microcode, a device driver, a redundant processing unit, an external disk drive array, a RAID system, a tape driver and a data backup and storage systems, etc.

Through the description of the above embodiments, those skilled in the art will readily understand that the exemplary embodiments described herein may be implemented by software or by software in combination with necessary hardware. Therefore, the technical solution according to an embodiment of the present disclosure may be embodied in the form of a software product, which may be stored in a non-volatile storage medium (which may be a CD-ROM, a USB disk, a mobile hard disk, etc.) or on the network, and include a number of instructions to cause a computing device (which may be a personal computer, a server, or a network device, etc.) to perform the above-described processing methods in accordance with embodiments of the present disclosure.

FIG. 8 is a schematic diagram illustrating a computer readable storage medium in an exemplary embodiment of the present disclosure.

Referring to FIG. 8, which depicts a program product 400 configured to implement the above method according to the embodiment of the disclosure. The program product 400 may employ a portable Compact Disk Read Only Memory (CD-ROM) and includes program codes and may run in a terminal device such as the personal computer. However, the program product of the present disclosure is not limited thereto, and in this document, the readable storage medium may be any tangible medium that contains or stores a program that can be used by or in connection with an instruction execution system, apparatus, or device.

Program code for performing the operation steps of the present application may be written in any combination of one or more programming languages, including an object oriented programming language such as Java, C++, etc., and also including conventional procedural Programming language such as the “C” language or a similar programming language. The program code can be executed entirely on the user computing device, partially on the user device, as a separate software package, partially on the user computing device and partially on the remote computing device, or entirely on the remote computing device or server. In the case of a remote computing device, the remote computing device can be connected to the user computing device via any kinds of network, including a local area network (LAN) or wide area network (WAN), or can be connected to an external computing device (eg, providing Internet connection using an Internet service provider).

The computer readable medium carries one or more programs, which when executed by the device, causes the computer readable medium to perform the following functions: determining the current attitude, the target attitude, and the moving speed of the robot; determining the moving path according to the third-order Bézier curve, the current attitude and the target attitude; determining the moving angular velocity according to the moving path and the moving speed; controlling the robot to move at the moving speed and the moving angular velocity so as to reach the target attitude.

It will be understood by those skilled in the art that the above various modules may be distributed in the device according to the description of the embodiments, or may be correspondingly changed to be located in one or more devices different from the embodiment. The modules of the above embodiments may be combined into one module, or may be split into multiple sub-modules.

Through the description of the above embodiments, those skilled in the art can readily understand that the exemplary embodiments described herein may be implemented by software or may be implemented by software in combination with necessary hardware. Therefore, the technical solution according to the embodiment of the present application may be embodied in the form of a software product, which may be stored in a non-volatile storage medium (which may be a CD-ROM, a USB flash drive, a portable hard disk, etc.) or on a network, and include a number of instructions to cause a computing device (which may be a personal computer, server, mobile terminal, or network device, etc.) to perform the method in accordance with embodiments of the present application.

[symbol]

Although the present invention has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘including’ does not exclude other steps or elements.

What is claimed is:

1. A method for controlling a movement of a robot, the method comprising:
determining a current attitude, a target attitude and a moving speed of the robot;
determining a moving path according to a third-order Bézier curve, the current attitude, and the target attitude;
determining a moving angular velocity according to the moving path and the moving speed; and
controlling the robot to move at the moving speed and the moving angular velocity so as to reach the target attitude.

2. The method according to claim 1, wherein the current attitude comprises a current position and a current azimuth, and the target attitude comprises a target position and a target azimuth, further wherein the step of determining the moving path according to the third-order Bézier curve, the current attitude and the target attitude comprises:
calculating parameters of the third-order Bézier curve according to the current position, the current azimuth, the target position, and the target azimuth; and
determining the moving path according to the parameters of the third-order Bézier curve.

3. The method according to claim 2, wherein the calculating the parameters of the third order Bézier curve according to the current position, the current azimuth, the target position, and the target azimuth comprises:
determining a start point and an end point of the third-order Bézier curve according to the current position and the target position;
determining a first intermediate point parameter equation and a second intermediate point parameter equation according to the start point, the end point, the current azimuth, and the target azimuth; and
solving the first intermediate point parameter equation and the second intermediate point parameter equation to obtain the parameters of the third order Bézier curve.

4. The method according to claim 3, wherein the solving the first intermediate point parameter equation and the second intermediate point parameter equation to obtain the parameters of the third order Bézier curve comprises:
solving the first intermediate point parameter equation by an optimization method with constraint to obtain a first intermediate point;
solving the second intermediate point parameter equation by the optimization method with constraint to obtain a second intermediate point; and
determining the parameters of the third-order Bézier curve according to the start point, the end point, the first intermediate point, and the second intermediate point.

5. The method according to claim 4, wherein an optimization objective of the optimization method comprises:
minimizing a value of a maximum curvature of the third-order Bézier curve.

6. The method according to claim 4, wherein the constraint of the optimization method comprises:
a maximum curvature of the third-order Bézier curve being less than a predetermined value; and
both of a value of the first intermediate point and a value of the second intermediate point being greater than zero.

7. The method according to claim 4, wherein the determining the moving path according to the parameters of the third-order Bézier curve comprises:
determining the moving path by introducing the parameters into a formula for third-order Bézier curve.

8. The method according to claim 1, wherein the determining the moving angular velocity according to the moving path and the moving speed comprises:
determining a speed update cycle for the robot;
determining a number of speed update for the robot;
determining a moving period; and
determining the moving angular velocity according to the moving period, the speed update cycle, and the number of speed update.

9. The method according to claim 8, wherein the determining the number of speed update for the robot comprises:
determining a path length of the moving path; and
determining the number of speed update according to the path length, the moving speed, and the speed update cycle.

10. The method according to claim 1, wherein the robot comprises a front turn rear drive robot.

11. A device for controlling a movement of a robot, the device comprising:
a state module configured to determine a current attitude, a target attitude, and a moving speed of the robot;
a path module configured to determine a moving path according to a third-order Bézier curve, the current attitude, and the target attitude;
an angular velocity module configured to determine a moving angular velocity according to the moving path and the moving speed; and
a moving module configured to enable the robot to move at the moving speed and the moving angular velocity so as to reach the target attitude.

12. The device according to claim 11, wherein the current attitude comprises a current position and a current azimuth; and the target attitude comprises a target position and a target azimuth;
the path module is further configured to:
calculate parameters of the third-order Bézier curve according to the current position, the current azimuth, the target position, and the target azimuth; and
determine the moving path according to the parameters of the third-order Bézier curve.

13. The device according to claim 12, wherein, the path module is further configured to:
determine a start point and an end point of the third-order Bézier curve according to the current position and the target position;
determine a first intermediate point parameter equation and a second intermediate point parameter equation according to the start point, the end point, the current azimuth and the target azimuth; and
solve the first intermediate point parameter equation and the second intermediate point parameter equation to obtain the parameters of the third order Bézier curve.

14. The device according to claim 13, wherein the path module is further configured to:
solve the first intermediate point parameter equation by an optimization method with constraint to obtain a first intermediate point;
solve the second intermediate point parameter equation by the optimization method with constraint to obtain a second intermediate point; and
determine the parameters of the third-order Bézier curve according to the start point, the end point, the first intermediate point, and the second intermediate point.

15. The device according to claim 11, wherein the angular velocity module is further configured to:
determine a speed update cycle for the robot;
determine a number of speed update for the robot;
determine a moving period; and
determine the moving angular velocity according to the moving period, the speed update cycle and the number of speed update.

16. The device according to claim 15, wherein the angular velocity module is further configured to:
determine a path length of the moving path; and
determine the number of speed update according to the path length, the moving speed, and the speed update cycle.

17. A robot, comprising:
a control system configured to determine a current attitude, a target attitude, and a moving speed of the robot; determine a moving path according to a third-order Bézier curve, the current attitude, and the target attitude; determine a moving angular velocity according to the moving path and the moving speed; and generate a moving command by determining the moving angular velocity according to the moving speed; and
a moving system configured to receive the moving command, and move the robot according to the moving command so as to reach the target attitude.

18. The robot according to claim 17, wherein the robot comprises:
a front turn rear drive robot.

19. An electronic apparatus, comprising:
one or more processors;
a memory configured for storing one or more programs;
wherein when being executed by the one or more processors, the one or more programs cause the one or more processors to implement the method of claim 1.

20. A computer readable medium having stored thereon a computer program, wherein the program implements the method of claim 1 when being executed by a processor.
